(19) United States
(12) Patent Application Publication
(10) Pub. No.: US 2024/0066856 A1
(43) Pub. Date: Feb. 29, 2024

(54) SCREEN PROTECTOR FILM APPLICATOR AND CELLPHONE SCREEN PROTECTOR FILM ASSEMBLY

(71) Applicant: Shenzhen Yumao Technology Co., Ltd., Shenzhen (CN)

(72) Inventor: Yonghui LIU, Shenzhen (CN)

(73) Assignee: Shenzhen Yumao Technology Co., Ltd., Shenzhen (CN)

(21) Appl. No.: 17/897,254

(22) Filed: Aug. 29, 2022

(51) Int. Cl. B32B 38/18; B32B 3/26; B32B 7/06; B32B 37/00; B32B 37/18; B32B 37/26

(52) U.S. Cl. CPC B32B 38/1841; B32B 3/266; B32B 7/06; B32B 37/0046; B32B 37/18; B32B 37/26; B32B 38/1808; B32B 2037/268; B32B 2307/748; B32B 2457/20; B32B 2571/00

(57) ABSTRACT

A screen protector film applicator includes a base. The base is provided with a screen accommodating space. The left and right sides of the screen accommodating space are provided with a left accommodating cavity and a right accommodating cavity, respectively. The front side of the screen accommodating space is provided with a front opening. The rear side of the screen accommodating space is provided with a pull-out opening. The center of the screen accommodating space is provided with a cushioning block. The left accommodating cavity is provided with left positioning posts. The right accommodating cavity is provided with right positioning posts. The technical solutions of the present invention have a simple structure and is easy to operate without the turning to professionals of applicating screen protector films or very strong hands-on skills that ordinary consumers can operate.

### TECHNICAL FIELD

The present invention relates to the technical field of the screen protection device for electronic products, particularly, a screen protector film applicator and a cellphone screen protector film assembly.

### BACKGROUND

To keep the screens of cellphones, tablets, and other digital electronic devices from being scratched during use, a layer of screen protector film is usually a to applied the screen to protect it from being scratched or damaged to a large extent. To facilitate the production and transfer, the screen protector film usually has a release film and a positioning film at the top and bottom of the screen protector film, respectively, thus the release film and the positioning film must be removed when the screen protector film is applicated.

The existing screen protector film applicating means are generally manual operations, which requires people having experienced skills of applying the screen protector film, such that the screen protector film can be applicated well at one time without generating bubbles. It is difficult for an unskilled person to accurately stick the screen protector film, so as to need be torn off and re-applicated. However, after repeated tearing and application, the adhesive surface of the screen protector film will be covered with dust resulting in bubbles forming during the screen protector film application, which may lead to the scrapping of the whole screen protector film.

Therefore, how to develop a screen protector film applicator to overcome the above shortcomings has become the subject of study for those skilled in the art.

### SUMMARY

The objective of the present invention is to provide a screen protector film applicator and a cellphone screen protector film assembly to address the shortcomings of the prior art.

The present invention achieves the above-mentioned objective through the following technical solutions by providing a screen protector film applicator that includes a base. The base is provided with a screen accommodating space. The left and right sides of the screen accommodating space are provided with a left accommodating cavity and a right accommodating cavity, respectively. The front side of the screen accommodating space is provided with a front opening. The rear side of the screen accommodating space is provided with a pull-out opening. The center of the screen accommodating space is provided with a cushioning block. The left accommodating cavity is provided with left positioning posts. The right accommodating cavity is provided with right positioning posts.

As a further solution of the present invention, the cushioning block is provided in a geometric structure with a height of 0.5 mm-4 mm.

As a further solution of the present invention, the present invention further includes a plurality of positioning member groups, and any one of the positioning member groups includes four positioning members. The base is provided with a rectangular slot. The four positioning members are removably and respectively connected to four corners of the rectangular slot and enclosed to form the screen accommodating space.

As a further solution of the present invention, any one of the positioning members in any one of the positioning member groups shows a right-angle trapezoidal structure, and an oblique side of the right-angle trapezoidal structure concaves to form a radian angle section. The bottom surface of any one of the positioning members is further provided with a positioning hole. The four corners of the rectangular slot are each provided with a positioning-member positioning post. The positioning-member positioning post is inserted into the positioning hole so that the four positioning members are respectively connected to the four corners of the rectangular slot.

As a further solution of the present invention, the four positioning members are a top left positioning member, a bottom left positioning member, a top right positioning member, and a bottom right positioning member, respectively, and the four corners of the rectangular slot are a top left corner, a bottom left corner, a top right corner, and a bottom right corner, respectively. The top left positioning member is placed in the top left corner, the bottom left positioning member is placed in the bottom left corner, the top right positioning member is placed in the top right corner, and the bottom right positioning member is placed in the bottom right corner.

The left accommodating cavity includes a gap formed by the top left positioning member and the bottom left positioning member, and the right accommodating cavity includes a gap formed by the top right positioning member and the bottom right positioning member.

As a further solution of the present invention, the present invention further includes a plurality of positioning frames. The base is provided with the rectangular slot. Any one of the plurality of positioning frames is embedded in the rectangular slot, and the screen accommodating space is arranged in the positioning frame.

As a further solution of the present invention, the screen accommodating space is provided with a pressing-type disassembling hole.

As a further solution of the present invention, the front opening is provided with front positioning posts.

As a further solution of the present invention, the present invention further includes a support rod and a pin. One end of the support rod is provided with a support rod hole. A side surface of the base is arranged with a first support rod connecting port. The back surface of the screen accommodating space protrudes to form a second support rod connecting port. One end, adjacent to the first support rod connecting port, of the second support rod connecting port is provided with a support rod limiting section. One end, adjacent to the support rod hole, of the support rod is provided between the first support rod connecting port and the second support rod connecting port. The pin inserts into the first support rod connecting port, the support rod hole, and the second support rod connecting port successively.

The present invention further provides another technical solution: a cellphone screen protector film assembly, which is applied to any one of the above-mentioned screen protector film applicators. The cellphone screen protector film assembly includes a cellphone screen protector film. One surface of the cellphone screen protector film is provided with a release film. One surface, facing away from the cellphone screen protector film, of the release film is provided with a pull-out tag. The other surface of the cellphone screen protector film is provided with a positioning film. The left and right sides of the positioning film are provided with a left positioning extension edge and a right positioning extension edge, respectively. The left positioning extension edge is provided with left positioning holes, and a right positioning extension edge is provided with right positioning holes.

The present invention has the following advantages.

The technical solutions of the present invention, by providing the screen accommodating space in the base, allow a cellphone screen and the cellphone screen protector film to be placed in the screen accommodating space. By arranging the left accommodating cavity, the right accommodating cavity, the left positioning posts, the right positioning posts, and the positioning film sticking to one surface of the cellphone screen protector film, the positioning film is fixed in the left accommodating cavity and the right accommodating cavity after the cellphone screen protector film is placed in the screen accommodating space, such that the cellphone screen protector film is fixed in the screen accommodating space. The release film is stuck to the other surface of the cellphone screen protector film, and the surface with the release film faces up, the surface with the positioning film faces down and abuts against the cushioning block. At the front opening, a tag on the release film is bent over to extend to the pull-out opening. One surface of the cellphone screen faces down to be placed in the screen accommodating space. The extended part of the tag of the release film is pulled out from the pull-out opening so that the release film is pulled out from the pull-out opening, and until the cellphone screen protector film is completely adhered and fitted to the cellphone screen.

The arrangement of the cushioning block, on the one hand, allows the cellphone screen protector film and the cellphone screen to be placed flatter in the screen accommodating space, avoiding damages to the applicating effect of the screen protector film because of the uneven placement. On the other hand, if the cellphone screen protector film is directly placed in the screen accommodating space without the cushioning block, the edge of the release film is prone to scratch the interior wall of the screen accommodating space when the release film is pulled out, leading to a clamping stagnation. The arrangement of the cushioning block allows the release film to be pulled out more smoothly, avoiding the clamping stagnation. The arrangement of the cushioning block provides the cellphone screen protector film and the cellphone screen with certain movable spaces when the release film is pulled out, and reserves enough space for pulling out the release film, which benefits the pulling out effect of the release film. Additionally, the arrangement of the cushioning block allows the release film to have a certain height. When the release film is pulled out, the cellphone screen protector film is automatically adhered and fitted to the cellphone screen by the gravity of the cellphone and a support from the cushioning block. The downward gravity surrounding the cellphone screen protector film and the support from the cushioning block allow the cellphone screen protector film to show a regular air-discharging process to reduce bubbles. Regular automatic adherence and reduction in bubbles generation allow the adherence between the cellphone screen protector film and the screen to automatically apply the screen protector film by gravity with a better applying effect.

The structure is so simple and easy to operate without the turning to professionals of applicating screen protector films or very strong fine motor skills that ordinary consumers can operate. The present invention provides accurate screen protector film positioning that has improved air-discharging effect, reduced bubble generation, is low cost, and has broad market prospects.

### BRIEF DESCRIPTION OF THE DRAWINGS

FIG. 1 is a schematic diagram showing one structure of a screen protector film applicator in the present invention.

FIG. 2 is a schematic diagram showing another structure of a screen protector film applicator in the present invention.

FIG. 3 is a schematic diagram showing yet another structure of a screen protector film applicator in the present invention.

FIG. 4 is an exploded diagram of a partial structure in FIG. 3.

FIG. 5 is a schematic diagram showing a structure of a positioning member in the present invention.

FIG. 6 is a schematic diagram showing a structural decomposition of a cellphone screen protector film assembly in the present invention.

FIG. 7 is a schematic diagram showing another structure of a release film in the present invention.

### REFERENCE NUMERALS IN THE DRAWINGS

100—base;
1—rectangular slot,
11—screen accommodating space, 12—left accommodating cavity, 13—right accommodating cavity, 14—front opening, 15—pull-out opening, 16—cushioning block, 17—positioning-member positioning post, 18—pressing-type disassembling hole,
111—top left corner, 112—bottom left corner, 113—top right corner, 114—bottom right corner,
121—left positioning post,
131—right positioning post,
141—front positioning post;
2—positioning member,
21—top left positioning member, 22—bottom left positioning member, 23—top right positioning member, 24—bottom right positioning member, 211—radian angle section, 212—positioning hole;
3—support rod,
31—support rod hole, 32—pin, 33—first support rod connecting port, 34—second support rod connecting port, 35—support rod limiting section;
4—cellphone screen protector film assembly,
41—cellphone screen protector film, 42—release film, 43—positioning film,
431—left positioning extension edge, 432—right positioning extension edge,
421—pull-out tag,
4311—left positioning hole,
4321—right positioning hole.

### DETAILED DESCRIPTION OF THE EMBODIMENTS

As follows, the present invention is described in detail in conjunction with the drawings.

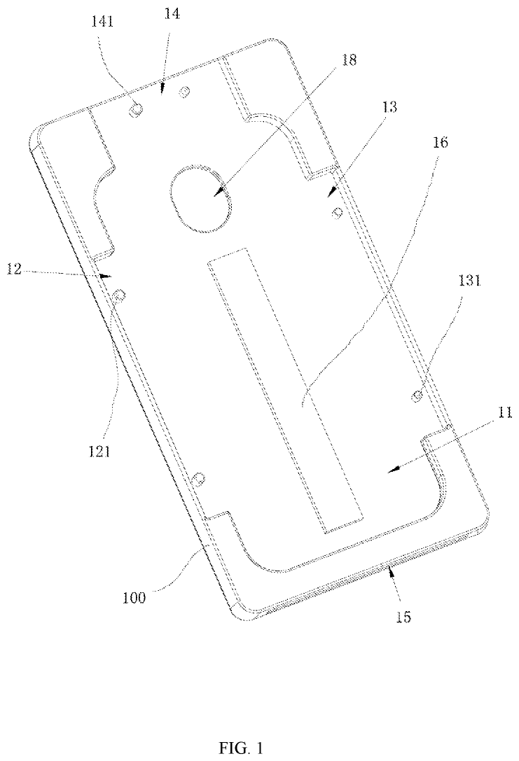

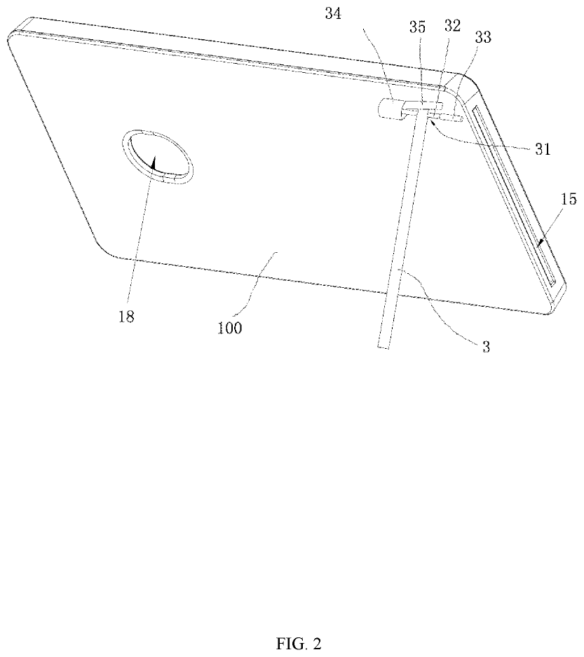

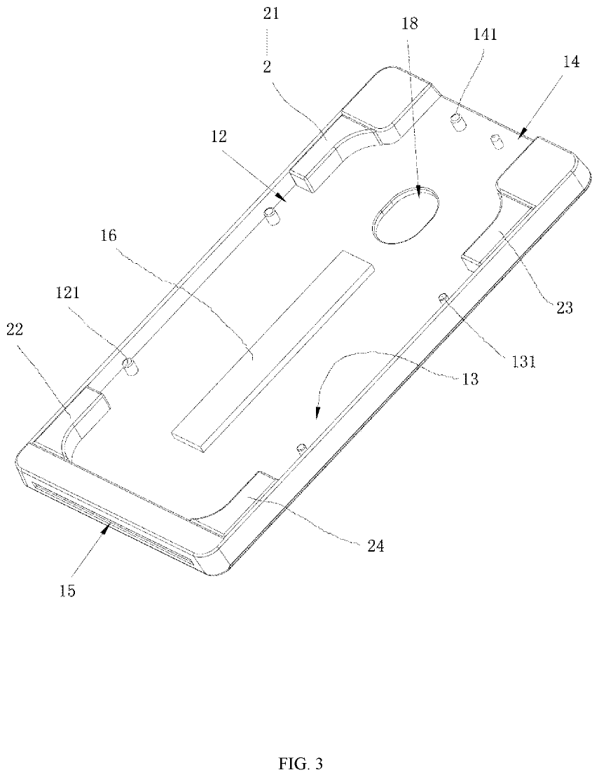

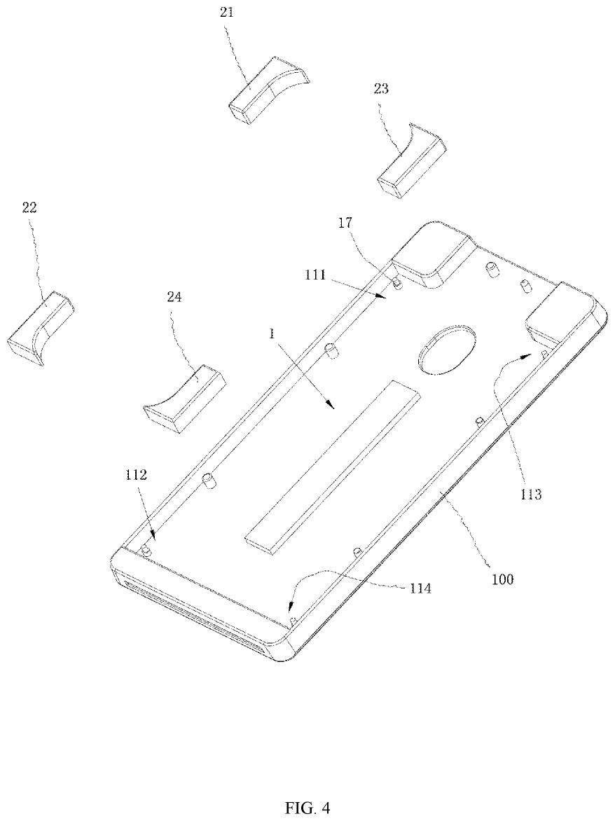

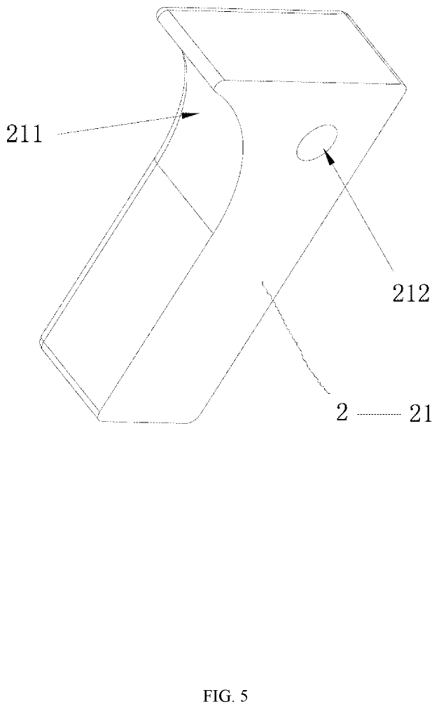

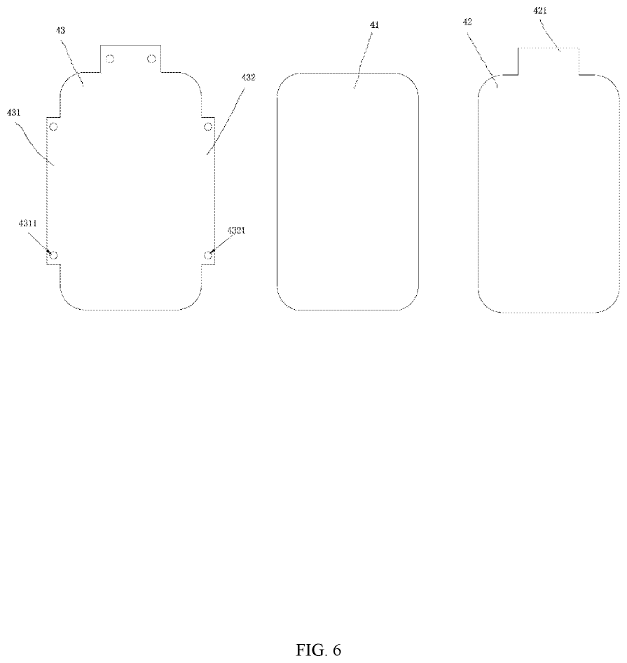

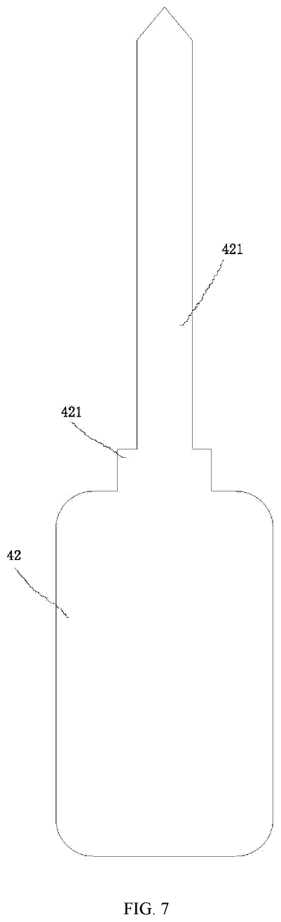

As shown in FIGS. 1 to 7, in the embodiment, the present invention provides a screen protector film applicator, including the base 100. The base 100 is provided with the screen accommodating space 11. The left and right sides of the screen accommodating space 11 are provided with the left accommodating cavity 12 and the right accommodating cavity 13, respectively. The front side of the screen accommodating space 11 is provided with the front opening 14. The rear side of the screen accommodating space 11 is provided with the pull-out opening 15. The center of the screen accommodating space 11 is provided with the cushioning block 16. The left accommodating cavity 12 is provided with the left positioning posts 121. The right accommodating cavity 13 is provided with the right positioning posts 131. Specifically, the cushioning block 16 can be fixedly arranged on the bottom surface of the screen accommodating space 11 by gluing or fixedly arranged on the bottom surface of the screen accommodating space 11 by integral molding. The cushioning block 16 can be the resilient cushioning block 16 or the non-resilient cushioning block 16, and the cushioning block 16 can be made of a foam pad. The cushioning block 16 can be fixedly arranged on the bottom of the screen accommodating space 11 by gluing, or fixedly arranged on the bottom of the screen accommodating space 11 by an integral injection molding with the base 100.

The technical solution of the present invention allows a cellphone screen and the cellphone screen protector film 41 to be placed in the screen accommodating space 11 by providing the base 100 with the screen accommodating space 11. By arranging the left accommodating cavity 12, the right accommodating cavity 13, the left positioning posts 121, the right positioning posts 131, and the positioning film 43 sticking to one surface of the cellphone screen protector film 41, the positioning film 43 is fixed in the left accommodating cavity 12 and the right accommodating cavity 13 after the cellphone screen protector film 41 is placed in the screen accommodating space 11, such that the cellphone screen protector film 41 is fixed in the screen accommodating space 11. The release film 42 is stuck to the other surface of the cellphone screen protector film 41, and the surface with the release film 42 faces up, the surface with the positioning film 43 faces down and abuts against the cushioning block 16. At the front opening 14, a tag on the release film 42 is bent over to extend to the pull-out opening 15. The cellphone screen faces down to be placed in the screen accommodating space 11. The extended part of the tag of the release film 42 is pulled out from the pull-out opening 15 so that the release film 42 is pulled out from the pull-out opening 15 until the cellphone screen protector film 41 is completely adhered and fitted to the cellphone screen.

The arrangement of the cushioning block 16, on the one hand, allows the cellphone screen protector film 41 and the cellphone screen to be placed flatter in the screen accommodating space 11, avoiding damages to the applicating effect of the screen protector film because of the uneven placement. On the other hand, if the cellphone screen protector film 41 is directly placed in the screen accommodating space 11 without the cushioning block 16, the edge of the release film 42 is prone to scratch the interior wall of the screen accommodating space 11 when the release film 42 is pulled out, leading to a clamping stagnation. The arrangement of the cushioning block 16 allows the release film 42 to be pulled out more smoothly, avoiding the clamping stagnation. The arrangement of the cushioning block 16 provides the cellphone screen protector film 41 and the cellphone screen with certain movable spaces when the release film 42 is pulled out, and reserves enough space for pulling out the release film 42, which benefits the pulling out effect of the release film 42. Additionally, when the release film 42 is pulled out, the arrangement of the cushioning block 16 allows a height difference between two ends of the cellphone, that is, placing the cellphone obliquely, by pressing on the end, away from the pull-out opening 15, of the cellphone. Therefore, it can be convenient to adjust the inclination angle of the cellphone when the release film 42 is pulled out, and the cellphone screen protector film 41 is gradually adhering and fitting to the cellphone screen. With the release film having a certain height, when the release film 42 is pulled out, the cellphone screen protector film 41 is automatically adhered and fitted to the cellphone screen by the gravity of cellphone and a support from the cushioning block 16. The downward gravity surrounding the cellphone screen protector film 41 and the support from the cushioning block 16 allow the cellphone screen protector film 41 to show a regular air-discharging process to reduce bubbles. Automatic adherence and reduction in bubble generation allow the adherence between the cellphone screen protector film 41 and the cellphone screen to automatically applicate the screen protector film by gravity with a better applicating effect.

The structure is so simple and easy to operate without the turning to professionals of applicating screen protector films or very strong hands-on skills that ordinary consumers can operate. The present invention provides accurate screen protector film positioning that has improved air-discharging effect, reduced bubble generation, is low cost, and has broad market prospects. In some embodiments, at least one cushioning block 16 is provided in a geometric structure with a height of In some embodiments, any one of the positioning members 2. Specifically, the number of the cushioning block 16 is one or at least two. Preferably, one cushioning block 16 is provided in a rectangular structure with a height of 3 mm. The preferable size of the cushioning block 16 maximizes the adhering effect between the cellphone screen protector film 41 and the cellphone screen.

In some embodiments, the present invention further includes a plurality of positioning member groups, and any one of the plurality of positioning member groups includes four positioning members 2. The base 100 is provided with the rectangular slot 1. The four positioning members 2 are removably and respectively connected to the four corners of the rectangular slot 1 and enclosed to form the screen accommodating space 11. The plurality of the positioning member groups is designed, and each one of the positioning member groups includes four positioning members 2. Each one of the positioning member groups corresponds to one type of cellphone in the current market, respectively, increasing the adaptiveness of the screen protector film applicator so that it is suitable in positioning and applicating screen protector films for a plurality of different cellphone types in the current market, and realizing a general screen protector film applicating function. Specifically, one type of cellphone corresponds to one group of the positioning members 2. When the other type of cellphone is changed to applicate a screen protector film, the screen accommodating space 11 formed by the group of the positioning members 2 that corresponds to last type of cellphone does not fit with the next type of cellphone. Therefore, the screen protector film applicating function with strong adaptiveness is realized by changing into the group of the positioning members 2 that corresponds to the next type of the cellphone to form up the screen accommodating space 11 that corresponds to and fits with the next type of the cellphone. That is, it is only required to change the corresponding group of the positioning members 2 when applying screen protector films for different types of cellphones, which effectively avoids frequently changing the screen protector film applicators.

In some embodiments, any one of the positioning members 2 in any one of the positioning member groups shows a right-angle trapezoidal structure, and an oblique side of the right-angle trapezoidal structure concaves to form the radian angle section 211. The bottom surface of any one of the positioning members 2 is further provided with the positioning hole 212. The four corners of the rectangular slot 1 are each provided with the positioning-member positioning post 17. The positioning-member positioning post 17 is inserted into the positioning hole 212 so that the four positioning members 2 are respectively connected to the four corners of the rectangular slot 1. Specifically, the radian angle section 211 fits with four radian angles of the cellphone screen protector film 41, that is, the four radian angles of the cellphone, further improving adaptiveness to apply screen protector films for different types of cellphones, and further enhancing the capability of positioning for applying screen protector films to further improve the applicating effects.

In some embodiments, the four positioning members 2 are the top left positioning member 21, the bottom left positioning member 22, the top right positioning member 23 and the bottom right positioning member 24, respectively. The four corners of the rectangular slot 1 are the top left corner 111, the bottom left corner 112, the top right corner 113 and the bottom right corner 114, respectively. The top left positioning member 21 is placed in the top left corner 111, the bottom left positioning member 22 is placed in the bottom left corner 112, the top right positioning member 23 is placed in the top right corner 113, and the bottom right positioning member 24 is placed in the bottom right corner 114.

The left accommodating cavity 12 includes the gap formed by the top left positioning member 21 and the bottom left positioning member 22, and the right accommodating cavity 13 includes the gap formed by the top right positioning member 23 and the bottom right positioning member 24, further improving adaptiveness to apply screen protector films for different types of cellphones, and further enhancing the capability of positioning for applying screen protector films to further improve the application effects.

In some embodiments, the present invention further includes a plurality of positioning frames. The base 100 is provided with the rectangular slot 1. Any one of the plurality of positioning frames is embedded in the rectangular slot 1, and the screen accommodating space 11 is arranged in the positioning frame. Specifically, different types of cellphones correspond to different positioning frames. Preferably, the top left positioning member 21, the bottom left positioning member 22, the top right positioning member 23 and the bottom right positioning member 24 are arranged in four corners of the positioning frame, respectively, that is, the frames of the positioning frame connect to the four positioning members 2, so that when the different type of cellphone is changed, the positioning frame can be changed more quickly, realizing the general screen protector film application function, which effectively avoids frequently changing the screen protector film applicators when applying screen protector films for different types of cellphones.

In some embodiments, the screen accommodating space 11 is provided with the pressing-type disassembling hole 18. Specifically, the arrangement of the pressing-type disassembling hole 18 allows the cellphone to be more easily taken out from the screen accommodating space 11 after the process of screen protector film application is finished, further improving adaptiveness to improve the application efficiency and user experience.

In some embodiments, the front opening 14 is provided with the front positioning posts 141. Specifically, the capability of positioning for applying screen protector films is further enhanced to further improve the application effects.

In some embodiments, the present invention further includes the support rod 3 and the pin 32. One end of the support rod 3 is provided with the support rod hole 31. A side surface of the base 100 is arranged with the first support rod connecting port 33. The back surface of the screen accommodating space 11 protrudes to form the second support rod connecting port 34. One end, adjacent to the first support rod connecting port 33, of the second support rod connecting port 34 is provided with the support rod limiting section 35. One end, adjacent to the support rod hole 31, of the support rod 3 is provided between the first support rod connecting port 33 and the second support rod connecting port 34. The pin 32 inserts into the first support rod connecting port 33, the support rod hole 31, and the second support rod connecting port 34 successively. Specifically, the support rod 3 rotates a certain degree until the support rod 3 abuts against the support rod limiting section 35. At this time, a certain angle is formed between the length direction of the support rod 3 and its projection on the base 100, resulting in the support rod 3 supporting the base 100. The cellphone is placed in the screen accommodating space 11, which allows the screen protector film applicator to be configured as a cellphone supporting frame, further increasing its adaptiveness and realizing multipurpose functions. The screen protector film applicator has a low production cost and a high practicality. After the screen protector film is applied, it can further act as a cellphone supporting frame. In addition, the effect of the screen protector film applicator supporting the cellphone can be achieved by sticking the gluable support frame to the back surface of the screen accommodating space 11, further increasing adaptiveness and user experience.

In some embodiment, the present invention includes a cellphone screen protector film assembly, which is applied to any one of the above-mentioned screen protector film applicators. The cellphone screen protector film assembly 4 includes the cellphone screen protector film 41. One surface of the cellphone screen protector film 41 is provided with the release film 42. One surface, away from the cellphone screen protector film 41, of the release film 42 is provided with the pull-out tag 421. The other surface of the cellphone screen protector film 41 is provided with the positioning film 43. The left and right sides of the positioning film 43 are provided with the left positioning extension edge 431 and the right positioning extension edge 432, respectively. The left positioning extension edge 431 is provided with the left positioning holes 4311, and the right positioning extension edge 432 is provided with the right positioning holes 4321. Specifically, the capability of positioning for applying screen protector films is further enhanced to further improve the application effects.

In operation, the cellphone screen protector film assembly 4 is placed in the screen accommodating space 11. The surface with the release film 42 faces up, and the surface with the positioning film 43 faces down. The left positioning extension edge 431 is placed in the left accommodating cavity 12, and the left positioning posts 121 are inserted in to the left positioning holes 4311. At the same time, the right positioning extension edge 432 is placed in the right accommodating cavity 13, and the right positioning posts 131 are inserted into the right positioning holes 4321. The front side of the positioning film is provided with a front positioning extension edge, and the front positioning extension edge is provided with the front positioning holes 212. The front positioning extension edge is arranged at the front opening 14, and the front positioning posts 141 are inserted into the front positioning holes 212. The pull-out tag 421 is arranged at one side, adjacent to the front positioning extension edge, of the release film 42. The pull-out tag 421 is bent over until the tail end of the pull-out tag 421 is inserted into the pull-out opening 15. The cellphone screen faces down to be placed in the screen accommodating cavity 11. One end, away from the pull-out opening 15, of the back surface of the cellphone is pressed. Meanwhile, since the cushioning block 16 is pressed, the one end pressed of the cellphone goes down slightly, resulting in that both the cellphone screen and the cellphone screen protector film 41 show certain obliqueness. Additionally, the extended part of the pull-out tag 421 is pulled out from the pull-out opening 15 until the pull-out tag 421 pulls out the release film 42 from the pull-out opening 15, leading to that the cellphone screen protector film 41 being adhered and fitted to the cellphone screen. Since the surface, fitting to the cellphone screen protector film 41, of the release film 42 has an electrostatic effect, such that when the release film 42 is pulled out, the dust on the cellphone screen will be attracted and taken out from the pull-out opening 15 simultaneously.

In addition, an elongated tag can be provided on the release film 42, and the pull-out tag 421 on the release film 42 can be made in a shorter size. In operation, the pull-out tag 421 is elongated by gluing the elongated tag on the pull-out tag 421, so as to pull out the release film 42 at the pull-out opening 15.

In summary, it can be seen that the present invention has the above-mentioned preferred characteristics, by which in practical operation, the present invention enhances the effectiveness which the prior art lacks and possesses practicability, and become a preferably practical product.

The above descriptions are only preferred embodiments of the present invention. For the ordinary skilled in the art, according to the idea of the present invention, the specific implementation and the scope of application may be changed. The content of this specification should not be understood as a limitation to limit the present invention.

What is claimed is:

1. A screen protector film applicator, comprising a base; wherein
the base is provided with a screen accommodating space;
a left side of the screen accommodating space is provided with a left accommodating cavity, and a right side of the screen accommodating space is provided with a right accommodating cavity, a front side of the screen accommodating space is provided with a front opening;
a rear side of the screen accommodating space is provided with a pull-out opening;
a center of the screen accommodating space is provided with a cushioning block, wherein the cushioning block extends along a majority of a length of the screen accommodating space and maximizes the adhering effect between the cellphone screen protector film and the cellphone screen;
the left accommodating cavity is provided with left positioning posts; and the right accommodating cavity is provided with right positioning posts.

2. The screen protector film applicator according to claim 1, wherein the cushioning block is provided in a geometric structure with a height in 0.5 mm-4 mm.

3. The screen protector film applicator according to claim 1, wherein the screen protector film applicator further comprises a plurality of positioning member groups; each of the plurality of positioning member groups comprises four positioning members; the base is provided with a rectangular slot; the four positioning members are removably and respectively connected to four corners of the rectangular slot, and the four positioning members enclose to form the screen accommodating space.

4. The screen protector film applicator according to claim 3, wherein each of the four positioning members in each of the plurality of the positioning member groups shows a right-angle trapezoidal structure; an oblique side of the right-angle trapezoidal structure concaves to form a radian angle section; a bottom surface of each of the four positioning members is further provided with a positioning hole; the four corners of the rectangular slot are each provided with a positioning-member positioning post; and the positioning-member positioning post is inserted into the positioning hole, wherein the four positioning members are respectively connected to the four corners of the rectangular slot.

5. The screen protector film applicator according to claim 3, wherein the four positioning members comprise a top left positioning member, a bottom left positioning member, a top right positioning member, and a bottom right positioning member, and the four corners of the rectangular slot comprise a top left corner, a bottom left corner, a top right corner, and a bottom right corner; the top left positioning member is placed in the top left corner, the bottom left positioning member is placed in the bottom left corner, the top right positioning member is placed in the top right corner, and the bottom right positioning member is placed in the bottom right corner;
the left accommodating cavity comprises a gap formed by the top left positioning member and the bottom left positioning member, and the right accommodating cavity comprises a gap formed by the top right positioning member and the bottom right positioning member.

6. The screen protector film applicator according to claim 1, wherein the screen protector film applicator further comprises a plurality of positioning frames; the base is provided with a rectangular slot; each of the plurality of positioning frames is embedded in the rectangular slot; and the screen accommodating space is arranged in each of the plurality of positioning frames.

7. The screen protector film applicator according to claim 1, wherein the screen accommodating space is provided with a pressing-type disassembling hole.

8. The screen protector film applicator according to claim 1, wherein the front opening is provided with front positioning posts.

9. The screen protector film applicator according to claim 1, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

10. A cellphone screen protector film assembly, wherein the cellphone screen protector film assembly is configured for the screen protector film applicator according to claim 1, wherein the cellphone screen protector film assembly comprises a cellphone screen protector film; a first surface of the cellphone screen protector film is provided with a release film, one surface, away from the cellphone screen protector film, of the release film is provided with a pull-out tag; a second surface of the cellphone screen protector film is provided with a positioning film; a left side of the positioning film is provided with a left positioning extension edge and a right side of the positioning film is provided with a right positioning extension edge; the left positioning extension edge is provided with left positioning holes, and a right positioning extension edge is provided with right positioning holes.

11. The screen protector film applicator according to claim 2, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

12. The screen protector film applicator according to claim 3, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

13. The screen protector film applicator according to claim 4, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

14. The screen protector film applicator according to claim 5, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

15. The screen protector film applicator according to claim 6, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

16. The screen protector film applicator according to claim 7, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; end, adjacent to the support rod hole, of the support rod is provided between the first support rod connecting port and the second support rod connecting port; and the pin inserts into the first support rod connecting port, the support rod hole, and the second support rod connecting port successively.

17. The screen protector film applicator according to claim 8, wherein the screen protector film applicator further comprises a support rod and a pin; one end of the support rod is provided with a support rod hole; a side surface of the base is arranged with a first support rod connecting port; a back surface of the screen accommodating space protrudes to form a second support rod connecting port; one end, adjacent to the first support rod connecting port, of the second support rod connecting port is provided with a support rod limiting section; one end, adjacent to the support rod hole, of the support rod is provided between the first support rod connecting port and the second support rod connecting port; and the pin inserts into the first support rod connecting port, the support rod hole, and the second support rod connecting port successively.

18. The cellphone screen protector film assembly according to claim 10, wherein in the screen protector film applicator, the cushioning block is provided in a geometric structure with a height in 0.5 mm-4 mm.

19. The cellphone screen protector film assembly according to claim 10, wherein the screen protector film applicator further comprises a plurality of positioning member groups; each of the plurality of positioning member groups comprises four positioning members; the base is provided with a rectangular slot; the four positioning members are removably and respectively connected to four corners of the rectangular slot, and the four positioning members enclose to form the screen accommodating space.

20. The cellphone screen protector film assembly according to claim 19, wherein in the screen protector film applicator, each of the four positioning members in each of the plurality of the positioning member groups shows a right-angle trapezoidal structure; an oblique side of the right-angle trapezoidal structure concaves to form a radian angle section; a bottom surface of each of the four positioning members is further provided with a positioning hole; the four corners of the rectangular slot are each provided with a positioning-member positioning post; and the positioning-member positioning post is inserted into the positioning hole, wherein the four positioning members are respectively connected to the four corners of the rectangular slot.
